(19) United States
(12) Patent Application Publication
(10) Pub. No.: US 2024/0411167 A1
(43) Pub. Date: Dec. 12, 2024

(54) MULTICURVED OPTICAL DEVICES, AND METHODS FOR MAKING SAME

(71) Applicant: ALPHAMICRON INCORPORATED, Kent, OH (US)

(72) Inventors: Paul LUCHETTE, Kent, OH (US); Roy MILLER, Stow, OH (US); Pedro SOTO, Kent, OH (US); Ludmila SUKHOMLINOVA, Kent, OH (US); Bahman TAHERI, Shaker Heights, OH (US)

(73) Assignee: ALPHAMICRON INCORPORATED, Kent, OH (US)

(21) Appl. No.: 18/698,782

(22) PCT Filed: Oct. 7, 2022
(86) PCT No.: PCT/US2022/045961

§ 371 Date: Apr. 5, 2024

Related U.S. Application Data
(60) Provisional application No. 63/262,277, filed on Oct. 8, 2021.

(51) Int. Cl. G02F 1/1333; G02F 1/1339; G02F 1/137

(52) U.S. Cl. CPC G02F 1/133305; G02F 1/133365; G02F 1/13394; G02F 1/13725; G02F 2202/022; G02F 2202/04; G02F 2202/28

(57) ABSTRACT

An optical device includes a low-flexibility carrier having a multicurved surface, a flexible liquid crystal film structure conformally provided over the multicurved surface, and an adhesive interposed between the multicurved surface and the liquid crystal film structure. The flexible liquid crystal film structure is lamination-formed to the shape of the multicurved surface. The carrier may be a window, a windshield, a cockpit, a display, a heads-up display, a sunroof, a mirror, a headset for augmented reality or virtual reality, goggles, a visor, a lens, glasses, or sunglasses.

### CROSS-REFERENCE TO RELATED APPLICATIONS

This application claims priority to, and any other benefit of, U.S. Provisional Patent Application Ser. No. 63/262,277 entitled MULTICURVED OPTICAL DEVICES, AND METHODS FOR MAKING SAME, Filed Oct. 8, 2021, the entire disclosure of which is fully incorporated herein by reference.

### TECHNICAL FIELD

The present disclosure relates to optical devices, particularly optical devices including a multicurved liquid crystal film structure.

### BACKGROUND

Liquid crystal (“LC”) devices offer a low cost, low power consumption approach to active light management. Traditionally, they have been employed for display applications using glass substrates. More recently, curved displays have entered the market. While the need for conformal devices has increased, the products to date have been limited to cylindrical shape (curved in one dimension). However, there is a large market for optical devices having curvature in two or more dimensions. Unfortunately, it is difficult to conform a flat device to a multicurved configuration because, among other reasons, it requires a change in the area to meet the topographic conditions.

A few solutions have been proposed for this issue. One solution is to create a curved LC device. This can be done by starting with multicurved substrates. These substrates can be thermoformed to the desired curvature a priori and then assembled (i.e., filled with LC mixture) in the conventional LC device manufacturing method. However, this approach has two fundamental difficulties which has hindered its growth. First, the curvatures of the two substrates have to be kept within the tolerance of the LC device configuration to maintain a constant gap between the LC substrates. Since this tolerance is only a few microns, fabrication of these substrates becomes very difficult and costly. Furthermore, this tolerance has to remain the same regardless of the size. This means that the curvature of the substrates would need to match across, for example, one meter for some applications. Holding a tolerance of a few microns over a meter is very difficult and expensive. Secondly, the difficulties associated with handling of two multicurved substrates significantly hinders large scale production. Current production systems are designed to handle large area flat glass.

Another approach is to fabricate a flat LC device (i.e. a device that already has two substrates assembled to maintain the desired gap with or without the LC mixture) and then thermoform the device to the final curved configuration, as described in U.S. Pat. Nos. 7,811,482, 7,705,959, and 7,102,602. Although the thermoforming method has provided some success in limited applications, the temperature of the LC device must be raised above the glass transition temperature of the substrates, which creates a new set of challenges relating to maintaining the structural integrity of the LC device during such heating. Solutions to this new problem generally require changing important features of the device itself, e.g., using a gel type of material such as used in suspended particle devices (SPD) or by adding polymer to avoid gap changes such as in polymer dispersed liquid crystal (PDLC) devices, but such device architecture changes may sacrifice critical performance attributes. Further, it should be noted that the glass transition temperature of many plastic substrates is above the nematic to isotropic transition temperature of the liquid crystal. As such, the thermoforming occurs while the liquid crystal is in a different (e.g., isotropic) phase. This can cause nonuniformity of the final device after it returns to operating temperatures due to change in the physical properties of the liquid crystal in the isotropic phase.

There is a need for multicurved small and large area LC devices that do not have the drawbacks associated with thermoformed LC devices. To this end, there is a need for a new approach for achieving multicurved devices having high optical clarity/low haze and low driving voltages.

### SUMMARY

In accordance with some embodiments of the present disclosure, an optical device includes a low-flexibility carrier having a multicurved surface, a flexible liquid crystal film structure conformally provided over the multicurved surface, and an adhesive interposed between the multicurved surface and the liquid crystal film structure. The flexible liquid crystal film structure is lamination-formed to the shape of the multicurved surface. The carrier may be a window, a windshield, a cockpit, a display, a heads-up display, a sunroof, a mirror, a headset for augmented reality or virtual reality, goggles, a visor, a lens, glasses, or sunglasses.

In accordance with some embodiments of the present disclosure, a method of making an optical device, the method includes providing a low-flexibility carrier having a multicurved surface and providing a flexible liquid crystal film structure. The flexible liquid crystal film structure may include a first flexible substrate and a second flexible substrate spaced apart from the first flexible substrate to form a gap designed to contain an electro-optic material, wherein an outer surface of the first flexible substrate corresponds to a first surface of the flexible liquid crystal film structure and an outer surface of the second flexible substrate corresponds to a second surface of the flexible liquid crystal film structure. The method further includes applying an adhesive to i) the multicurved surface, ii) the first surface of the flexible liquid crystal film structure, or iii) both (i) and (ii). The carrier is aligned to the flexible liquid crystal film structure and pressure is applied between the multicurved surface and the first surface of the flexible liquid crystal film structure to shape the flexible liquid crystal film structure in accordance with the multicurved surface of the carrier. The method further includes conformally adhering the shaped flexible liquid crystal film structure to the multicurved surface.

### BRIEF DESCRIPTION OF DRAWINGS

FIG. 1 is a perspective schematic diagram of an optical device according to some embodiments of the present disclosure.

FIG. 2 is a cross-sectional diagram illustrating the flexible liquid crystal film structure according to some embodiments of the present disclosure.

FIG. 3 is a perspective schematic diagram of a multicurved surface according to some embodiments of the present disclosure.

FIG. 4 is a perspective schematic diagram of a multicurved surface and a projected virtual area according to some embodiments of the present disclosure.

FIG. 5 is a cross-sectional diagram of an optical device according to some embodiments of the present disclosure.

FIG. 6 is a cross-sectional diagram of an optical device according to some embodiments of the present disclosure.

FIG. 7 is a block diagram illustrating the steps for making an optical device according to some embodiments of the present disclosure.

FIGS. 8A-8G are a series of cross-sectional diagrams showing the construction of an optical device according to some embodiments of the present disclosure.

FIG. 9A is a cross-sectional diagram of a roller according to some embodiments of the present disclosure.

FIG. 9B is a cross-sectional diagram of a roller according to some embodiments of the present disclosure.

FIGS. 10A-10D are a series of cross-sectional diagrams showing the construction of an optical device according to some embodiments of the present disclosure.

FIG. 11 is a cross-sectional view of an optical device according to some embodiments.

### DETAILED DESCRIPTION

Various technologies pertaining to multicurved optical devices and methods for making the same are now described with reference to the drawings. It is to be understood that the drawings are for purposes of illustrating the concepts of the disclosure and may not be to scale.

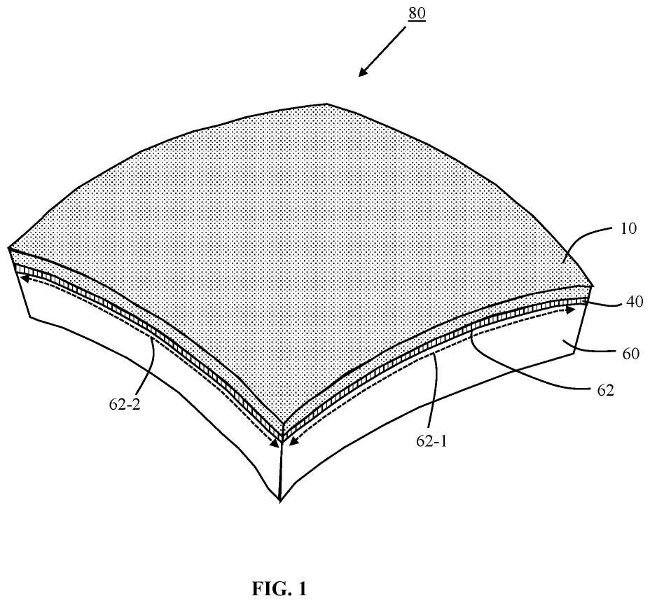

FIG. 1 is a perspective schematic diagram of an optical device according to some embodiments of the present disclosure. Optical device 80 includes a carrier 60 having a multicurved surface 62 including at least a first curvature 62-1 along a first axis and a second curvature 62-2 along a second axis. Optical device 80 further includes a flexible liquid crystal film structure 10 conformally provided over the multicurved surface 62. An interposed adhesive 40 adheres the flexible liquid crystal film structure 10 to the multicurved surface 62. The flexible liquid crystal film structure is lamination-formed to the shape of the multicurved surface. Additional details for each of these elements are provided below.

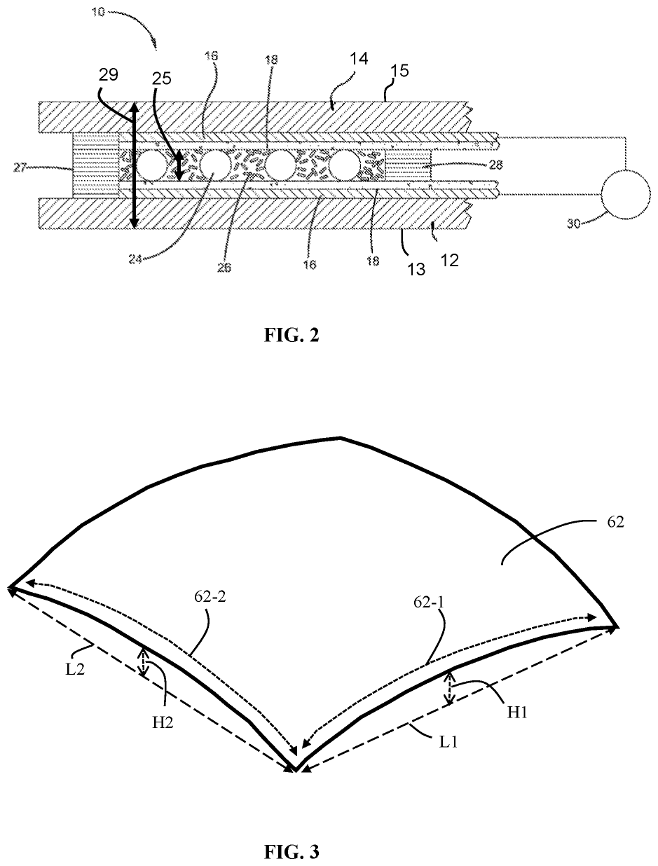

FIG. 2 is a cross-sectional diagram illustrating the flexible liquid crystal film structure 10 according to some embodiments. In some embodiments, the flexible liquid crystal film structure may be a variable transmission device that may be used to darken windows, visors, AR/VR goggles, glasses, or the like, as discussed elsewhere herein. The flexible liquid crystal film structure 10 includes first substrate 12 and second substrate 14. The outer surface of first substrate 12 corresponds to a first surface 13 of the flexible liquid crystal film structure 10. The outer surface of second substrate 14 corresponds to a second surface 15 of the flexible liquid crystal film structure 10. Depending on the application, the substrates may optionally be coated with a conductive layer 16. Optically clear conductive layers include Indium Tin Oxide (ITO), conductive polymers, conductive nanowires and the like. Alternatively, or in addition, the substrates may also be coated with an alignment layer 18, such as a polyimide or the like.

Substrates 12 and 14 are made of a clear flexible material such as a clear plastic or flexible glass suitable for constructing flexible liquid crystal film structure units, sometimes referred to as “cells”. Substrates 12 may be the same as, or different than, substrate 14 with respect to chemical composition, thickness, optical clarity or other features. Suitable plastics include, for example, a polycarbonate (PC), a polycarbonate and copolymer blend, a polyethersulfone (PES), a polyethylene terephthalate (PET), cellulose triacetate (TAC), a polyamide, p-nitrophenylbutyrate (PNB), a polyetheretherketone (PEEK), a polyethylenenapthalate (PEN), a polyetherimide (PEI), polyarylate (PAR), a polyvinyl acetate, a cyclic olefin polymer (COP) or other similar plastics known in the art. Flexible glass include materials such as Corning® Willow® Glass and the like. Plastic substrates are generally preferred herein when a flexible liquid crystal film structure is lamination-formed to a multicurved surface. Many of these substrates are commercially available from, e.g., Mitsubishi Plastics or Teijin DuPont films, and may come standard with various optional coatings such as hard coats. As used here, “clear” means a material having higher than 45% transmission to visible radiation having a wavelength between 450 nm and 700 nm. In some examples, the clear substrate can have a transmission of 50%, 60%, 70%, or 80%. In some embodiments, substrate 14 may have higher optical transmission or lower haze relative to substrate 12. In some embodiments, one or both substrates include a flexible polymeric material having an ultimate tensile strength of less than 300 MPa, alternatively less than 200 MPa, or 100 MPa. In some embodiments, one or both substrates include a flexible polymeric material having an ultimate tensile strength in a range of 20-50 MPa, 50-100 MPa, 100-150 MPa, 150-200 MPa, 200-300 MPa, 300-500 MPa, or any combination of ranges thereof. In some embodiments, one or both substrates include a flexible polymeric material having a Young's modulus of less than 10 GPa, alternatively less than 5 GPa.

In some embodiments, the thickness of a substrate 12 or 14 may be in a range of 10-20 μm, 20-30 μm, 30-40 μm, 40-50 μm, 50-75 μm, 75-100 μm, 100-150 μm, 150-200 μm, 200-250 μm, 250-300 μm, 300-350 μm, 350-400 μm, 400-450 μm, 450-500 μm, 500-600 μm, 600-800 μm, 800-1000 μm, or any combination of contiguous ranges thereof.

The substrates 12, 14 are generally separated by a controlled gap 25 or distance, which may in some embodiments be maintained by spacers 24. The volume between the substrates is filled by an electro-optic material (“EOM”) 26.

The spacers 24 may be used to maintain a controlled distance or gap between the substrates. In some embodiments, the controlled gap 25 is in a range of 3-4 μm, alternatively 4-5 μm, 5-6 μm, 6-7 μm, 7-8 μm, 8-9 μm, 9-10 μm, 10-12 μm, 12-14 μm, 14-16 μm, 16-18 μm, 18-20 μm, 20-25 μm, 25-30 μm, 30-40 μm, 40-50 μm, 50-60 μm, 60-80 μm, 80-100 μm, or any combination of contiguous ranges thereof. A “controlled” gap or distance means the variation in the distance between the substrates should remain within on the average less than 30% of spacer diameter (which determines the controlled gap). In some embodiments, the variation is less than 25%, 20%, 15%, 10% or 5% of the spacer diameter. In some embodiments, the gap across an active area of the liquid crystal film structure is maintained with 30% of an average gap measured over the active area.

Generally, two kinds of spacers may be used to maintain a controlled distance between substrates according to various embodiments of the present disclosure. One category includes “patterned spacers”, which are spacers that are either purposefully placed or created on a substrate to form a predetermined pattern, or they are created using photolithography or similar method known in the art and which produce a desired pattern. Examples include polymer walls. In some cases, patterned spacers may have a length and width that are larger than the flexible liquid crystal film structure gap, i.e., they possess an aspect ratio of long side to flexible liquid crystal film structure gap that is >20 in a pattern that can produce visible patterns in the device, which may be undesirable.

Another category includes “unpatterned spacers”, which are defined herein as spacers that are placed randomly (e.g. sprayed on) or printed where they are positioned in a way so as not to produce optical aberrations such as diffraction patterns or the like. The unpatterned spacers of the present disclosure may be spherical or they can be oblong with an aspect ratio (length/width) less than 30/1, 20/1, 10/1, 5/1, 4/1, or 3/1. The spacers are used to maintain a distance between the substrates of 3-100 μm, preferably 4-20 μm or 5-10 μm.

As used herein, a “diffraction pattern” occurs when the periodic light pattern created by light propagation through a periodic structure with spacing of the structure being less than 100 times the wavelength of incident light, i.e., where the periodicity of the repeated pattern (e.g. of spacers or AGCs) is less than 100 times the wavelength of light.

In some embodiments, device performance is better when the substrates are covered with a greater density of smaller spacers than when long patterned spacers are placed in select locations. In some embodiments, the spacer count is at least 80 per square mm (mm²).

In some embodiments, the spacers 24 may be pre-applied to the substrates (e.g., the sheets are pre-coated with spacers) or may be applied to the substrates during the EOM filling process, e.g., during a roll-filling process. For example, spacers 24 may be sprayed on or applied in a layer where the spacers are randomly arranged or are arranged in a on-diffraction-producing pattern. They may be dispersed using a wet or dry method as known in the art. The spacers may be placed or sprayed on top of the alignment layer (18 of FIG. 2) or may be placed within the alignment layer. In some embodiments, the spacers may contain an adhesive element, for example they can be coated with an adhesive layer (not illustrated)

Spherical spacers are distinct from the spherical encapsulated liquid crystals such as those described in FERGASON, Patent Application of, PCT/US1982/001240 (WO/1983/001016) entitled: “Encapsulated Liquid Crystal and Method”, because they do not encapsulate any volume of the EOM.

In certain embodiments, the spacers 24 can be deposited inside or as part of the alignment layer 18, so that they are applied when the alignment layer is applied to one or both substrates. In other embodiments, the spherical spacers 24 can be integrated into the electro-optic material that is deposited onto the substrates.

In some embodiments, the flexible liquid crystal film structure 10 further includes a border seal (edge seal) 27/28, which contains the EOM 26 inside the flexible liquid crystal film structure and forms a barrier between the outside environment and the EOM, preventing the EOM 26 from flowing out of the flexible liquid crystal film structure as well as preventing environmental factors (air, moisture, debris) from getting inside the flexible liquid crystal film structure. In some examples, the border seal 27/28 is formed by applying a border sealant to one or both of the substrates 12,14, which when brought together and cured, will form the border seal around the EOM contained within the flexible liquid crystal film structure. In some embodiments, the active area or portion of the flexible liquid crystal film structure corresponds to the area where the EOM is confined by the border seal.

Methods for including the EOM within the flexible liquid crystal film structure 10 are well-known in the art. For example, in some embodiments, EOM 26 may be injected into the gap of the flexible liquid crystal film structure 10 using a vacuum filling process or a one drop filling process. In the case of the vacuum filling process, the edge seal around the flexible liquid crystal film structure 10 is not yet continuous and has an opening referred to as a “fill hole”. The flexible liquid crystal film structure 10 is then placed in a vacuum chamber to vacate the air from within the flexible liquid crystal film structure 10. After this step, and while still under vacuum, the EOM 26 is introduced to the fill hole. The EOM then fills the gap inside the flexible liquid crystal film structure 10 due to capillary forces. This may be accelerated by bringing the flexible liquid crystal film structure 10 to atmospheric pressure after the EOM introduction to the fill hole. The process is completed once the EOM has filled the flexible liquid crystal film structure gap. In some cases, to avoid future problems (e.g., shrinkage, formation of bubbles, etc.) the amount of EOM in the flexible liquid crystal film structure 10 may be more than the anticipated volume. In such cases, the flexible liquid crystal film structures 10 are then pressed to remove the excess EOM by a process referred to as “cold pressing”. The fill hole is then sealed, e.g., by using an epoxy to avoid air from entering the flexible liquid crystal film structure.

The EOM filling processes referred to as one drop filling or ODF are well-known in the art and can be used to fill the flexible liquid crystal film structures.

In some embodiments, EOM 26 may be introduced using a roll-filling method, e.g., as disclosed in U.S. Pat. No. 11,435,610 (Miller et al.) the entire contents of which are incorporated herein by reference for all purposes.

FIG. 2 shows the variation in the border seal 27/28 depending on the various coatings on the substrates 12, 14 when the border seal is applied. In FIG. 2, on one side, border seal 27 seals the flexible substrates 12, 14 together. Alternatively, the border seal arrangement can be as pictured on the other side of the flexible liquid crystal film structure 10 with border seal 28 sealing the gap between the alignment 18 and/or conductive layers 16. The particular arrangement will depend on the timing and method of the border seal application and filling of the EOM 26.

The border seal 27/28 can be applied using any technique known in the art, including but not limited to, using brushes, rollers, films or pellets, spray guns, applicator guns, screen printing, inkjet printing, flexographic printing, planar coating, roller pressing, or thermal pressing, or any combination thereof. All of these can be done manually or can be automated into a machine, or a combination thereof. The border seal can be a suitable adhesive (UV, thermal, chemical, pressure, multi-part epoxies, and/or radiation cured), polyisobutylene or acrylate-based sealants, and so on, or a pressure sensitive adhesive, a two-part adhesive, a moisture cure adhesive, etc. Other types of border (edge) seal can be composed of metallized foil or other barrier foil adhered over the edge of the flexible liquid crystal film structure. It has been found that hybrid radiation and thermal cure sealants (i.e., UV curable with thermal post-bake) may offer certain advantages. In some embodiments, Threebond 30Y-491 material (from Threebond Corporation, Cincinnati, Ohio) can be especially useful because of its favorable water vapor barrier properties, low viscosity at elevated temperature for easy depositing of the edge seal material, good wetting characteristics, and manageable curing properties. Those skilled in the art and familiar with advanced sealants will be able to identify other sealants that offer comparable performance.

The flexible liquid crystal film structure 10 is filled with an electro-optic material (EOM) 26. The electro-optic material can be any material that is responsive to an electric field applied across the flexible liquid crystal film structure so as to have a desired operating characteristic intended for the device and includes any material that can be altered by the application of an electric current or voltage. For example, the EOM may be one or a combination of a liquid crystal material, an electro-chromic material, a suspended particle device (SPD), with other additives such as dyes (dichroic dyes, pleochroic dyes, etc.), and the like, where the electro-optic material can be altered by the application of an electric current or voltage. In a preferred embodiment, the EOM is a guest-host liquid crystal-dichroic dye mixture.

In some embodiments, the electro-optic material as a whole is not polymerizable, non-encapsulated and non-discrete. Thus, in these embodiments, the EOM excludes polymeric or encapsulated liquid crystal compositions such as PDLC, PELC, PSCT, PNLC, NCAP, or the like.

As used herein, “not polymerizable” means an EOM composition that does not include chemical components (e.g., polymer precursors) in an amount necessary to dimensionally stabilize the EOM layer by changing the phase of the material to a solid, a semi-solid, or a gel, etc. A non-polymerizable EOM contains <10% polymerizable material.

“Non-discrete” means an EOM that is not divided into discrete, separate compartments by encapsulation, polymer walls, polymer networks, patterned spacers, or the like.

“Non-encapsulated” means an EOM that is not contained within the confines or interior volume of a capsule. A capsule refers to a containment device or medium that confines a quantity of an EOM, such as a liquid crystal, so that an “encapsulated EOM” is a quantity of EOM confined or contained in an encapsulating medium, e.g., a polymer capsule. The capsules may have a spherical shape, or may have any other suitable shape. Encapsulated EOM (e.g., encapsulated liquid crystals) are made to prevent them from flowing. Some non-limiting examples of encapsulated EOMs include polymer-dispersed liquid crystals (PDLCs), which consist of droplets of liquid crystals inside a polymer network.

For example, a method of microencapsulation is described by FERGASON in U.S. Pat. No. 4,435,047 entitled: “Encapsulated liquid crystal and method” (1984) and in Patent Application PCT/US1982/001240 (WO/1983/001016) entitled: “Encapsulated Liquid Crystal and Method.” In this method, a resin material is used to encapsulate the liquid crystal (LC) material to form curved, spherical capsules containing discrete quantities of LC material. These are made by mixing together LC material and an encapsulating medium (e.g., a resin) in which the LC material will not dissolve and permitting formation of discrete capsules containing LC material. In the micro-encapsulation, the liquid crystal is mixed with a polymer dissolved in water. When the water is evaporated, the liquid crystal is surrounded by the polymer. A large number of tiny “capsules” are produced and distributed through the bulk polymer. Materials manufactured by encapsulation are referred to as NCAP or nematic curvilinear aligned phase.

In alternative embodiments, the EOM may include mesogenic polymerizable components, such as found in PNLC or PSCTs and the like.

In yet other embodiments, the EOM may include polymer materials such as found in PDLC or NCAP, created using commonly known processes such as as PIPS (Polymerization Induced Phase Separation), SIPS (Solvent Induced Phase Separation), TIPS (Temperature Induced Phase Separation), or the like.

In some embodiments, e.g., where the flexible liquid crystal film structure size is large, in addition to unpatterned spacers, the flexible liquid crystal film structure may contain one or more Adhesive Gap Control elements or AGCs. An AGC is an adhesive element placed either randomly or in a non-diffracting pattern and assists in the adherence of the two flexible liquid crystal film structure substrates 12, 14. In some embodiments, AGC elements are walls that form a matrix inside the flexible liquid crystal film structure unit, but do not divide the flexible liquid crystal film structure in terms of its electrical connectivity, i.e., the flexible liquid crystal film structure and its EOM is activated by a single electrical connection and the flexible liquid crystal film structure or the device as a whole is not pixelated or segmented

In other embodiments, where the conductive layer 16 (e.g. ITO) contains segmented regions, the AGCs may be used to divide the segments (i.e., the AGC's will coincide with the segment borders). In yet other embodiments, where the conductive layer contains segmented regions, the AGCs may not coincide with the ITO segment borders.

In some embodiments, the EOM includes a “guest-host” liquid crystal-dye mixture where the mixture includes a quantity of one or more dichroic dye “guests” mixed inside a liquid crystal “host” solution. The liquid crystal “host” molecules have an axis of orientation that is alterable by adjustment of a voltage applied across the substrates. The “guest” dye mixture includes one or more dichroic dyes which are dissolved within the liquid crystal host, align with the orientation of the liquid crystal molecules and whose absorption of polarized light strongly depends on the direction of polarization relative to the absorption dipole in the dye molecule. An applied voltage results in a switch between a first state, where the guest-host orientation allows maximum light transmission, referred to here as the “clear state”, and a second state, where the guest-host orientation allows minimum light transmission, referred to here as the “dark state”, and a combination of intermediate states, between the fully clear and fully dark states. Depending on the composition of the guest-host mixture, the clear state can occur at zero voltage (Off state). Alternatively, the mixture may be formulated so that zero voltage (Off state) corresponds to a dark (minimum transmission) state. In some embodiments, the EOM may optionally further include a photochromic (PC) dye or a photochromic-dichroic (PCDC) dye whose light absorbance may be activated by exposure to UV light such as sunlight. In some embodiments, the EOM may further include a small amount of a conventional absorbing dye, e.g., to provide the device with a desired overall hue in the clear state.

Flexible liquid crystal film structures containing guest-host liquid crystal-dye mixtures are particularly well-suited for manufacture according to the methods described herein because of their greater tolerance for variation within the flexible liquid crystal film structure gap, i.e. the flexible liquid crystal film structure is more forgiving and can function well even if the flexible liquid crystal film structure gap has slight variations (within acceptable limits such as +/−5%, 10%, 15%, 20%, 25% or even 30% of the spacer diameter) as compared with flexible liquid crystal film structures relying on phase retardation, such as polarizer-based LC devices, where the tolerance or variation in flexible liquid crystal film structure gap has to be kept to <1%.

In some embodiments, the guest-host liquid crystal-dye mixtures described above are used to attenuate light in the optical device (e.g., where the carrier is a pair of glasses, AR or VR goggles, visors, a window, a windshield, a cockpit, or the like).

In operation, a flexible liquid crystal film structure having a clear state (maximum transmission) at zero voltage (Off state) can be achieved, for example, where the guest-host liquid crystal-dye mixture has a homeotropic alignment (i.e., perpendicular to the substrates). When no voltage is applied, the liquid crystal host has negative dielectric anisotropy and the dichroic dyes have positive dichroism, i.e., having maximal absorption when the polarization is parallel to the long molecular axis of the dye molecule and a minimal absorption when the polarization is perpendicular to the long axis. In such a device, when upon application of a voltage (ON state), the guest-host mixture assumes a planar or homogeneous alignment, i.e., parallel to the substrates, and becomes maximally light absorbing (dark). Such an arrangement can be used in, for example, goggles, eyewear, visors, etc., where it may be desirable to “darken” the device in response to a voltage applied when there is bright light. Other applications include windows (vehicles, buildings, aircrafts, etc.), sun/moon roofs, display devices and the like.

In other examples the reverse alignment can be implemented so that the guest-host liquid crystal-dye mixture can have a planar alignment (homogeneous) in a dark state, when the applied voltage is OFF, and a homeotropic alignment in the clear state when voltage is applied. This can be achieved by use of a planar surface treatment for the alignment layers in conjunction with a dye having positive dichroism and a liquid crystal material with positive dielectric anisotropy. Such an arrangement may be used in, for example, a window or sunroof, where it is desirable for the device to be normally in a “dark” state, but capable of switching to a clear state by application of a voltage.

Referring again to FIG. 2, the flexible liquid crystal film structure 10 may be connected to a control circuit 30 for application of an electric field or voltage across the flexible liquid crystal film structure. The voltage source may be either AC or DC.

In some embodiments the flexible liquid crystal film structure 10 has a thickness 29 in a range of 100-150 μm, 150-200 μm, 200-250 μm, 250-300 μm, 300-350 μm, 350-400 μm, 400-450 μm, 450-500 μm, 500-600 μm, 600-700 μm, 700-800 μm, 800-900 μm, 900-1000 μm, or any combination of contiguous ranges thereof.

### Adhesives

### Pressure Activated Adhesives

In some cases, the adhesive may be a pressure-activated adhesive (“PAA”) which is a material that increases its tackiness or adhesion upon application of pressure. In some embodiments, the PAA includes a viscoelastic polymer and optionally a tackifier. The PAA may include an acrylate polymer, a silicone polymer, a natural rubber, or a thermoplastic elastomer. The PAA may further include a resin (e.g., rosins and their derivates, terpenes and modified terpenes, aliphatic, cycloaliphatic and aromatic resins (C5 aliphatic resins, C9 aromatic resins, and C5/C9 aliphatic/aromatic resins), hydrogenated hydrocarbon resins, and their mixtures, terpene-phenol resins (TPR, used often with ethylene-vinyl acetate adhesives)), or Novolacs. The PAA may be moisture resistant.

In some embodiments, the PAA is supplied as a roll and provided between a backing and a release layer, both of which are removed when used as described later. Application of heat or UV radiation is generally not required when using a PAA. However, in some embodiments, heat or UV or some other treating processes may be used in a post-lamination step to further stabilize the system.

### Curable Adhesives

In some embodiments, the adhesive may be formed from a curable material or precursor that contains a chemically reactive functional group or component that causes a change to the adhesive during a curing step. A curing step may include a heat treatment, UV radiation, component mixing, exposure to air, or some other curing process. Curing by a heat treatment should be at a temperature that is compatible with the flexible liquid crystal structure. In some cases, curing causes a polymerization or other reaction that forms the adhesive capable of bonding the liquid crystal film structure to the carrier. For example, the curable material may include an epoxy, a cyanoacrylate, an acrylic ester, an alkylene-vinyl-acetate, or some other curable reactive material. The curable material itself may be in the form of a liquid, gel, or a pre-formed film. In some embodiments, a curable adhesive may be used in conjunction with a PAA.

### Hot Melt Adhesives

In some embodiments, the adhesive may be a hot melt adhesive that does not require curing, but is activated by excursions to higher temperatures to cause softening and/or melting. Some non-limiting examples of hot melt materials include polyolefins and thermoplastic polyurethanes. For example, a hot melt film may be provided between a liquid crystal film structure and a carrier. Upon application of heat and pressure, the hot melt film softens to form an adherent film (the adhesive). Some typical heating temperatures are 50° C., 60° C., 80° C. or even 100° C. or above. Generally, a heating temperature or time is selected to be effective and compatible with the EOM and flexible liquid crystal film structure. For example, the liquid crystal EOM and/or substrates may be selected to accommodate such elevated temperatures. However, such selections may limit design freedom for making the flexible liquid crystal film structure, so in some cases, hot melt adhesives may be less preferred. A hot melt adhesive may be used in combination with a PAA.

The adhesive may have a thickness of 10-15 μm, 15-20 μm, 20-25 μm, 25-30 μm, 30-40 μm, 40-50 μm, 50-60 μm, 60-70 μm, 70-80 μm, 80-90 μm, 90-100 μm, 100-125 μm, 125-150 μm, 150-175 μm, 175-200 μm, 200-250 μm, 250-500 μm, or any combination of contiguous ranges thereof.

In some embodiments, rather than using a single layer of an adhesive material, multiple sublayers of the adhesive may be stacked to form the adhesive 40. Such sublayers may have the same or different chemical composition or thickness. For example, a first PAA may adhere better to the flexible liquid crystal film structure, a second PAA may adhere better to the carrier and the first and second PAA sublayers adhere well to each other.

In some cases, the adhesive should be able to form a relatively uniform film between the multicurved surface 62 and the first surface 13 of the flexible liquid crystal film structure 10. In some embodiments, “relatively uniform” means having a thickness with a variation within 30% of an average thickness, alternatively within 20%, 15%, or 10%. In some embodiments, the PAA is optically clear.

In some embodiments, the adhesive and the liquid crystal film structure together transmit at least 40% of visible light in a wavelength range of 450 nm to 700 nm, alternatively at least 50%, 60%, 70%, 80%, 85%, or 90%. In some embodiments, the adhesive and the liquid crystal film structure together provide a haze value in the off state or maximum transmission state of less than 15%, 10%, 7%, 5%, 3%, 2% or 1%. In some embodiments, the ratio of the average thickness of the liquid crystal film structure relative to the average thickness of the adhesive is less than 10, 8, or 5.

### Multicurved Surface and Carrier

As mentioned, the carrier includes a multicurved surface. The multicurved surface of FIG. 1 is just one of many possible examples. As used herein, a “multicurved surface” means a non-planar shape having compound curves, also referred to as non-developable shapes, which include but are not limited to a spherical surface, an aspherical surface, and a toroidal surface, where the curvature of two orthogonal axes (horizontal and vertical one) are different, which may be for example a toroidal shape, an oblate spheroid, oblate ellipsoid, prolate spheroid, prolate ellipsoid, or where the surface's principle curvature along two orthogonal planes are opposite, for example a saddle shape or surface, such as a horse or monkey saddle. Other examples of a multicurved surfaces include, but are not limited to, an elliptic hyperboloid, a hyperbolic paraboloid, and a spherocylindrical surface, where the multicurved surface may have constant or varying radii of curvature. The multicurved surface may also include segments or portions of such surfaces, or be comprised of a combination of such curves and surfaces. In some embodiments, the multicurved surface may have radii of curvature along two orthogonal axes. In various embodiments, the multicurved surface may be asymmetrical.

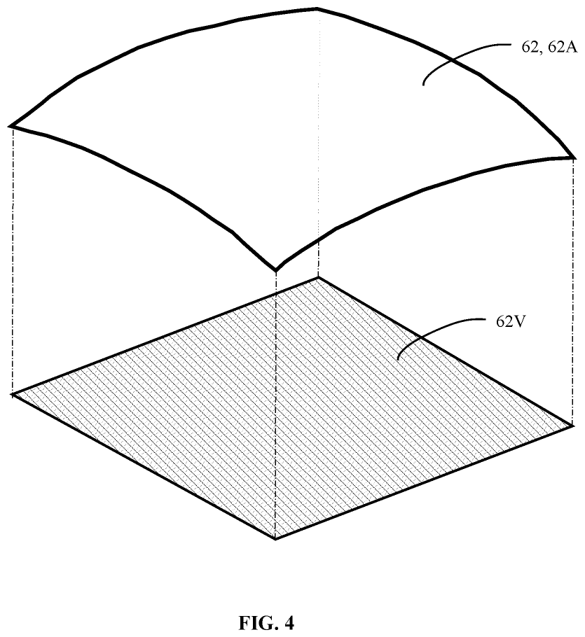

Referring to FIG. 3, a multicurved surface 62 may in some cases be characterized as having a first curvature 62-1 having a first height H1 and a first length L1 measured along a first direction, wherein a first curvature ratio C1=H1/L1. The multicurved surface may be further characterized as having a second curvature 62-2 having a second height H2 and second length L2 measured along a second direction different from the first direction, wherein a second curvature ratio C2=H2/L2. In some embodiments the second direction may be orthogonal to the first direction. Although shown as positive values where curvature height is measured above an imaginary plane formed by L1 and L2, in some embodiments, one or both of C1 and C2 could be negative where the height is the distance below the plane. In some embodiments such as shown in FIG. 3, L1 and L2 may correspond to the entire point-to-point lengths corresponding to the portions intended for lamination with the flexible liquid crystal film structure. In some embodiments, L1 and L2 may instead correspond to a portion of the multicurved surface defining the lengths between inflection points in the curves. In some embodiments, both C1 and C2 are non-zero, and the absolute value of at least one or optionally both of C1 and C2 is less than 1, 0.9, 0.8, 0.7, 0.6, 0.5, 0.4. 0.3, 0.2, 0.1, 0.05, 0.02, 0.01, 0.005, 0.002, or 0.001. Alternatively, the curvature at any point can be described in terms of a local “diopter” defined as D=0.5/R where R is the radius of curvature in any one direction at the point measured in meters. In some cases, the D in any one direction can be less than or equal to 8, 7, 6, 5, 4, 3, 2, 1, 0.5, or 0.2.

In some embodiments, the multicurved surface 62 may be characterized by a first curvature 62-1 curved to a first value of greater than 0 diopter, and a second curvature 62-2 along a different axis than the first curvature and curved to a second value of greater than 0 diopter. In some embodiments, the second curvature may be orthogonal to the first curvature. One or both of the first value and the second value is less than 10, 8, 6, 5, 4, 3, 2, or 1.

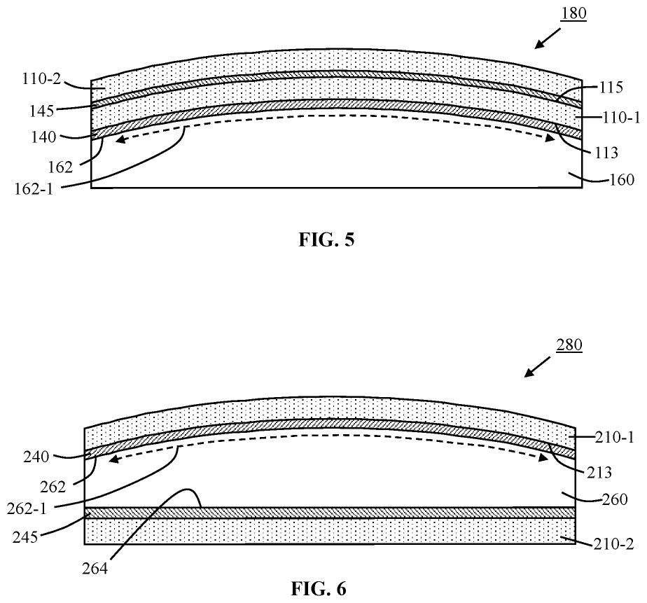

Referring to FIG. 4, the surface area 62A of the multicurved surface 62 is greater than the virtual area 62V defined by a projection of the multicurved surface onto a flat surface. Relative to virtual area 62V, surface area 62A may be greater in a range of 0.1-0.2%, 0.2-0.3%, 0.3-0.4%, 0.4-0.5%, 0.5-0.6%, 0.6-0.7%, 0.7-0.8%, 0.8-1.0%, 1.0-1.2%, 1.2-1.4%, 1.4-1.6%, 1.6-1.8%, 1.8-2.0%, 2.0-2.5%, 2.5-3.0%, 3.0-3.5%, 3.5-4.0%, 4.0-4.5%, 4.5-5%, 5-6%, 6-7%, 7-8%, 8-9%, 9-10%, 10-11%, 11-12%, 12-13%, 13-14%, 14-15%, 15-20%, or any combination of contiguous ranges thereof.

The flexible liquid crystal film structure is lamination-formed to the shape of the multicurved surface by a lamination formation process as described below. A flexible liquid crystal film structure that has been subjected to lamination formation may be referred to herein as a lamination-formed liquid crystal film structure. A lamination-formed liquid crystal film structure may have a surface area that has been changed relative to the original flexible liquid crystal film structure. In some cases, the active portion of a lamination-formed liquid crystal film structure may cover the entire carrier. In some embodiments, the active portion of a lamination-formed liquid crystal film structure may cover only a portion of the carrier.

In some non-limiting examples, the carrier may function as a window, a windshield, a cockpit, a display, a heads up display, a sunroof, a mirror, a headset (e.g., augmented reality or virtual reality headsets), goggles, a visor, a lens, glasses (including, for example, sunglasses or AR/CR glasses), or some other eyewear. There is no particular limitation on the carrier, but in most embodiments, it transmits (or reflects if a mirror) at least 10% of visible light in a wavelength range of 450 nm to 700 nm. In some embodiments, the carrier transmits at least 40%, 50%, 60%, 70%, 80%, 90%, or 95% of visible light in a wavelength range of 450 nm 700 nm. In some embodiments, the carrier may transmit light or reflect light with low light scattering. In some cases, the carrier may purposefully have a frosted appearance or scatter light, e.g., as with privacy windows. In some cases, the carrier may appear clear or colorless, but in some embodiments, the carrier may have a hue or color. In general, at least the portion of a carrier to which the liquid crystal film structure is attached has a lower flexibility than the liquid crystal film structure, i.e., a “low-flexibility carrier”. A low-flexibility carrier may include a carrier material (e.g., glass, metal, certain plastics, or composites) having a Young's modulus of at least 10 GPa, or alternatively at least 20 GPa, 30 GPa, 40 GPa, 50 GPa, 60 GPa, 70 Gpa, 80 GPa or 90 Gpa. In some embodiments, a low-flexibility carrier may be characterized as having a shear modulus of at least 10 GPa, or alternatively at least 20 GPa. In some embodiments, the combined thickness of the adhesive and the liquid crystal film structure is less than 2%, 1%, 0.5%, or 0.2% of the maximum length of the carrier in any dimension over which the liquid crystal film structure is provided.

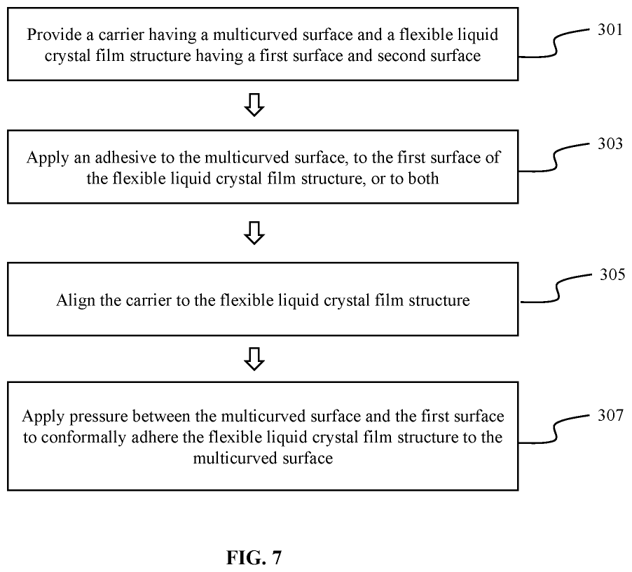

In some embodiments, an optical device may include two or more liquid crystal film structures. For example, FIG. 5 is a cross sectional view of optical device 180 similar to that shown in FIG. 1 having carrier 160 with multicurved surface 162, an adhesive layer 140 over the multicurved surface 162 and a first flexible liquid crystal film structure 110-1 having a first surface 113 provided over the adhesive. This cross-section shows only a first curvature 162-1. First flexible liquid crystal film structure 110-1 may be as described above including first and second substrates, EOM, spacers, alignment layers, conductive layers, and other features, but these are omitted for clarity. In FIG. 5, the optical device further includes an adhesive layer 145 over a multicurved second surface 115 of the first flexible liquid crystal film structure 110-1. Adhesive layer 145 may be the same or different than adhesive layer 140. A second flexible liquid crystal film structure 110-2 may be provided over the adhesive layer 145. The second flexible liquid crystal film structure may be the same as or different from the first flexible liquid crystal film structure with respect to materials, physical properties and/or function. The second flexible liquid crystal film structure may be lamination-formed to the shape of the multicurved surface second surface 115 of the first flexible liquid crystal film structure.

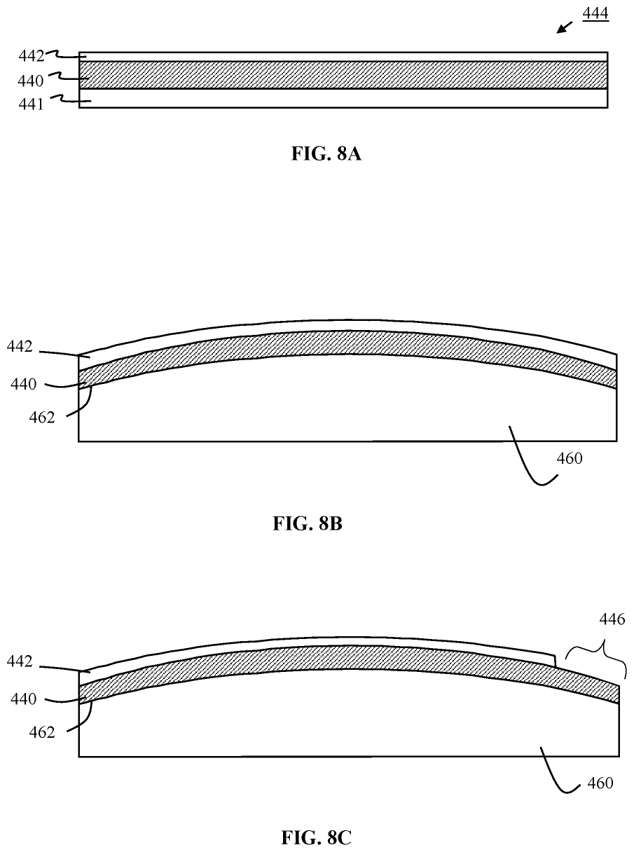

In some embodiments, an optical device may have flexible liquid crystal film structures on opposite sides of the carrier. For example, FIG. 6 is a cross sectional view of optical device 280 similar to that shown in FIG. 1 having carrier 260 with multicurved surface 262, adhesive layer 240 over the multicurved surface 262 and a first flexible liquid crystal film structure 210-1 having a first surface 213 provided over the adhesive. This cross-section shows only a first curvature 162-1. First flexible liquid crystal film structure may be as described above including first and second substrates, EOM, spacers, alignment layers, conductive layers, and other features, but these are omitted for clarity. In FIG. 6, the optical device further includes an adhesive layer 245 in contact with an opposite surface 264 of the carrier. Opposite surface 264 may be flat, curved, or multicurved. Adhesive layer 245 may be the same or different than adhesive layer 240. A second flexible liquid crystal film structure 210-2 may be provided in contact with adhesive layer 245. The second flexible liquid crystal film structure may be the same as or different from the first flexible liquid crystal film structure with respect to materials, physical properties or function.

### Lamination Forming

The various steps result in a lamination-formed liquid crystal film structure and may collectively be referred to herein as lamination forming. As described herein, lamination forming generally involves the use of an adhesive and application of pressure to change the shape of the flexible liquid crystal film structure, but does not include temperatures that approach transition temperatures of the flexible liquid crystal film structure such as a substrate glass transition temperature or Tg or the EOM nematic-isotropic transition temperature (TNI) or both. In some embodiments, steps used in lamination forming that involve the flexible liquid crystal film structure may be conducted at a temperature that is at least 10° C. lower than a substrate Tg or an EOM (TNI). In some cases, steps used in lamination forming that involve the flexible liquid crystal film structure may be conducted at a temperature of less than 70° C., alternatively less than 60° C., 50° C., 40° C., 30° C., or 20° C. Such steps may optionally be carried out at room temperature (e.g., in a range of 15-25° C.). These temperature ranges may correspond to the temperature measured at the flexible liquid crystal film structure itself. In some cases, a lamination component or tool may have a higher temperature than listed above, but the temperature of the flexible liquid crystal structure may stay within the aforementioned ranges, e.g., by limiting the time that it is exposed to the heated lamination component or tool. Lamination forming may in some cases cause some stretching or compression of one or both substrates of a flexible liquid crystal film structure.

In some preferred embodiments, he term “lamination-formed” refers to the fact that the curvature of the lamination formed flexible liquid crystal structure has undergone a permanent change (i.e., at least some change in curvature from its pre-lamination state) while still maintaining electro-optic properties. For example, if a lamination-formed flexible liquid crystal structure were to be de-adhered from its carrier, it would possess a different curvature than prior to lamination forming.

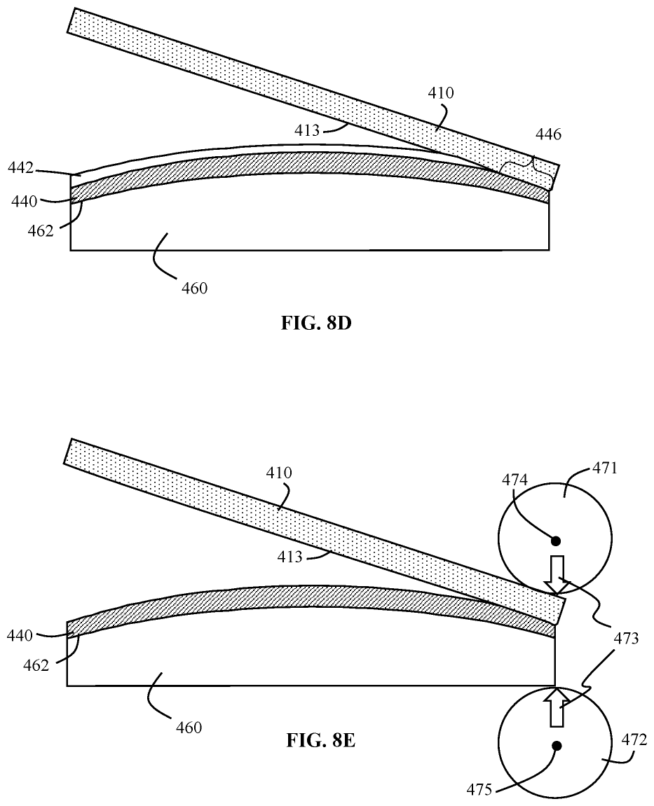

FIG. 7 is a block diagram illustrating the steps for making an optical device by lamination forming according to some embodiments of the present disclosure. In step 301, a carrier having a multicurved surface is provided along with a flexible liquid crystal film structure having a first surface and a second surface. The carrier and flexible liquid crystal film structure have been described above.

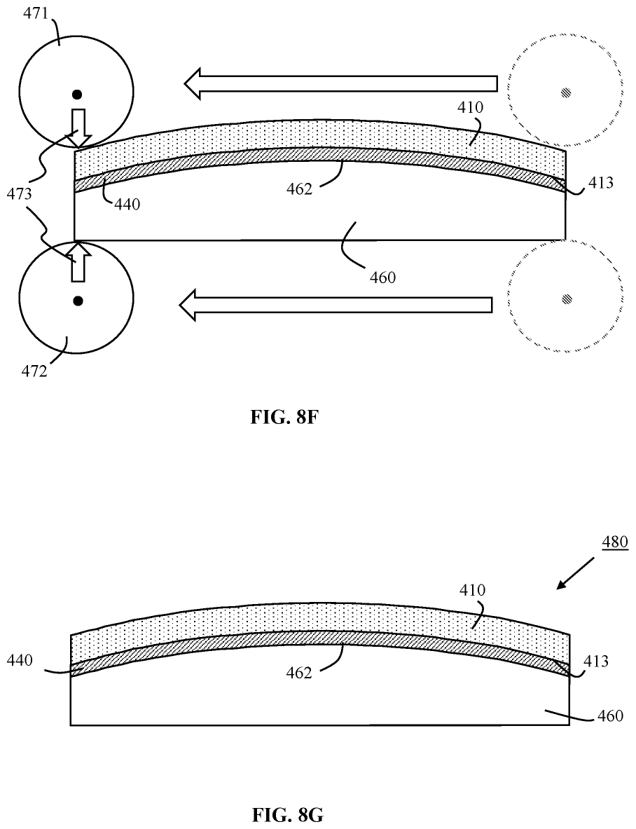

In step 303, an adhesive is applied to the multicurved surface of the carrier, or to the first surface of the flexible liquid crystal film structure. Alternatively, an adhesive material may be applied to both the multicurved surface of the carrier and to the first surface of the flexible liquid crystal film structure. FIGS. 8A-8G are a series of cross-sectional views illustrating the construction of an optical device using a PAA according to some embodiments of the present disclosure. As mentioned and shown in cross-sectional view FIG. 8A, the PAA 440 may in some embodiments be provided between a backing layer 441 and a release liner 442 (collectively PAA precursor sheet 444). In some embodiments, as shown in FIG. 8B, the PAA precursor sheet may be pre-cut to the desired size prior and backing layer 441 may be removed and the exposed PAA surface may be applied to the target surface, e.g., multicurved surface 462 of carrier 460 and/or the first surface of the flexible liquid crystal film structure. Application of the PAA onto the target surface may include the use of one or more rollers or a mold to ensure uniform application. In some embodiments, as shown in FIG. 8C a portion of release layer 442 may be removed to form exposed portion 446 of the PAA 440. PAA 440 may include any of the materials or properties previously discussed.

In some embodiments, a liquid glue (not illustrated) may also be used in conjunction with the PAA. Such liquid glue may be applied to the PAA or to the surface intended to receive and bond with the PAA. In some cases, the liquid glue may help eliminate air bubbles as the structures are brought together and laminated. In some embodiments, a liquid other than a glue may be applied to the PAA or to the surface intended to receive and bond with the PAA, e.g., a wet lamination for eliminating trapped air. The liquid may be a solvent-based material.

In step 305, the carrier is aligned to the flexible liquid crystal film structure. This may be done using a jig, a mold, or some other tooling. In some embodiments as shown in FIG. 8D part of the alignment may include contacting one edge of the flexible liquid crystal film structure 410 with the PAA, for example, exposed portion 446 of the PAA with first surface 413 of the liquid crystal film structure. Contact may initially be soft so as to make alignment adjustments. Once alignment is achieved, harder contact may be made to secure the structure to the carrier. Flexible liquid crystal film structure 410 may be as described above including first and second substrates, EOM, spacers, alignment layers, conductive layers, and other features, but these are omitted for clarity.

In step 307, pressure is applied between the multicurved surface and the first surface of the flexible liquid crystal film structure to conformally adhere the flexible liquid crystal film structure to the multicurved surface. In some embodiments, as shown in FIG. 8E, the aligned structure from FIG. 8D is provided into a roller assembly including at least a top roller 471 and optionally a bottom roller 472 designed to provide pressure 473 between the multicurved surface and the first surface of the flexible liquid crystal film structure. The rollers may optionally include internal axles 474 and 475 about which the rollers rotate. The remaining portion of release layer 442 is removed. In FIG. 8F, the roller assembly applies pressure and moves across the carrier and flexible liquid crystal film structure to laminate the carrier and flexible liquid crystal film structure together thereby forming optical device 480 shown in FIG. 8G. The roller assembly itself may move, or alternatively the carrier and flexible liquid crystal film structure may move through the roller assembly, or both. Although not shown, in some embodiments a curable liquid or gel adhesive material may be applied to the PAA after the release layer 442 is removed (FIG. 8E) and subsequently cured, e.g., by UV radiation, as the leading edge exits the rollers.

In some embodiments, the pressure 473 applied along the length of at least the top roller between the multicurved surface and the first surface of the flexible liquid crystal structure is within 50% of the average pressure applied, alternatively within 40%, 30%, 20% or 10%.

In some embodiments, at least one roller 471, 472 is a deformable roller capable of substantially conforming to the multicurved surface 462 as the lamination process advances. A deformable roller may include a compressible material. In some cases, a deformable roller may have a durometer in a range of less than 90, 80, 70, or 60. A deformable roller may include multiple segments along its length, e.g., internal wheels, to independently adjust the applied force at each segment to improve overall uniformity of the applied pressure along the roller. In other embodiments, a deformable roller may include a flexible roller wherein an internal axel 474 of the roller flexes in response to pressure applied to the multicurved surface.

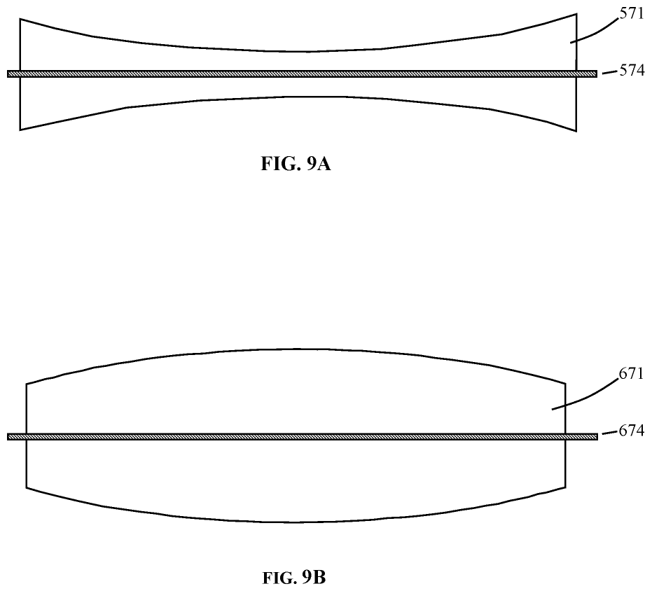

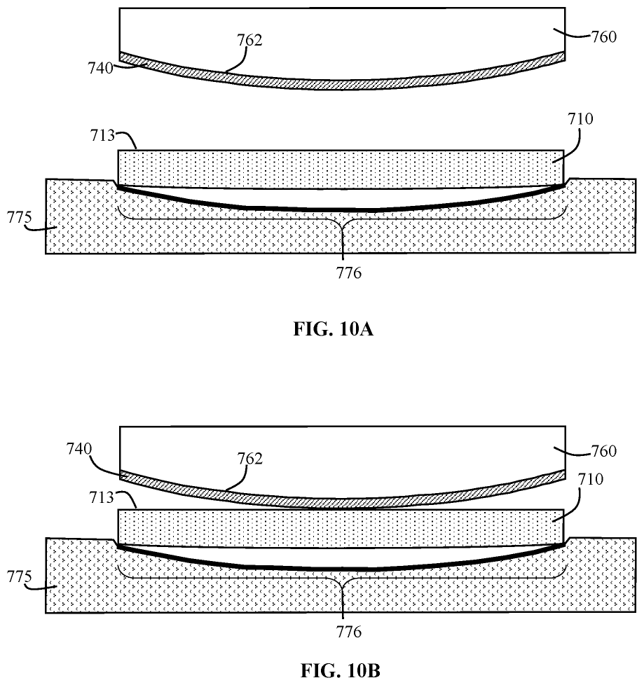

When applying pressure to a convex multicurved surface, a roller 471 may have a concave lateral shape where the roller radius at the middle of the roller length is less than the radius at the ends of the roller. This is shown in cross section in FIG. 9A along the length of the roller 571 including internal axle 574. In addition to the shape, roller 571 may further be a deformable roller. When applying pressure to a concave multicurved surface, the roller may have a convex lateral shape where the roller radius at the middle of the length is larger than at the ends of the roller. This is shown in cross section in FIG. 9B along the length of roller 671 including internal axle 674. In addition to the shape, roller 671 may further be a deformable roller.

In some embodiments, the rollers may be heated to improve adhesion, but such heating should be kept below the Tg of the first or second substrates of the flexible liquid crystal film structure. For example, the rollers may be heated to a temperature of at least 30° C. but at least 10° C. lower than the Tg of either substrate. In some embodiments, the roller surface may have a coating or treatment that discourages unwanted adhesion between the second surface of the flexible liquid crystal film structure and the roller. For example, such coating or treatment, may include application of a fluorinated polymer or surface groups.

In some embodiments, rather than rolling, the elements described as “rollers” described above may simply slide across the surface as long as the friction between the element and the liquid crystal film structure is low. Alternatively, other shaped elements may be used to apply a uniform pressure.

Rather than using rollers to apply pressure, a mold having a shape (“mold face”) corresponding to the multicurved surface may be used. The mold face does not have to be identical to the multicurved surface shape, but in some embodiments, the mold face is sufficiently similar to the multicurved surface so that the pressure applied across the multicurved surface within 50% of the average pressure, alternatively within 40%, 30%, 20% or 10%.

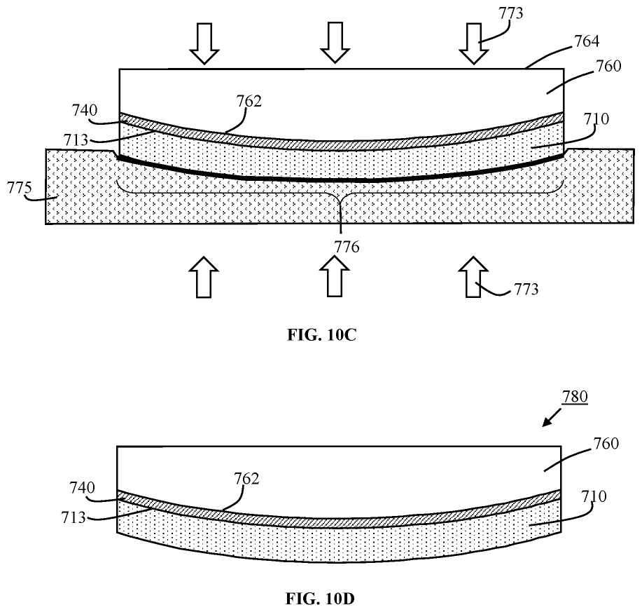

FIGS. 10A-10D are a series of cross-sectional views illustrating a non-limiting embodiment of using a mold to apply pressure as in Step 307. In FIG. 10A, a carrier 760 with adhesive 740 is aligned to flexible liquid crystal film structure 710 having a first surface 713. Flexible liquid crystal film structure 710 may be as described above including first and second substrates, EOM, spacers, alignment layers, conductive layers, and other features, but these are omitted for clarity. Flexible liquid crystal film structure 710 is positioned in mold 775 having a mold face 776 similar in shape to the multicurved surface 762. The flexible liquid crystal film structure 710 is generally flat in this figure, but may alternatively be partially curved. In FIG. 10B, the carrier, adhesive and flexible film structure are moved together to make an initial contact. Such contact (as shown here) may be at or near the center of the multicurved surface, but not necessarily. In FIG. 10C, force 773 is applied between the mold and the opposite surface 764 of the carrier (opposite side to the multicurved surface 762) to cause the flexible liquid crystal film structure to conformally adhere and make optical device 780 (FIG. 10D). In some embodiments, force applied at the opposite surface of the carrier may include use of second mold having a second face similar to the shape of the opposite surface.

In some embodiments, the mold(s) may be heated to improve adhesion, but such heating should be kept below the Tg of the first or second substrates of the flexible liquid crystal film structure. For example, the mold(s) may be heated to a temperature of at least 30° C. but at least 10° C. lower than the Tg of either substrate. If the adhesive is not a PAA, then a curing step may be included while the parts are in position as in FIG. 10C.

In some embodiments, the mold may have some flexibility to allow improved contact and uniform pressure application especially when the mold face is not identical to the multicurved surface. In some cases, the mold may be more flexible than the carrier but less flexible than the flexible liquid crystal film structure. In some embodiments, the mold face may have a coating or treatment that discourages unwanted adhesion between the second surface of the flexible liquid crystal film structure and the mold face. For example, such coating or treatment, may include application of a fluorinated polymer or surface groups.

In some embodiments, more pressure may be applied to an outer area of the flexible liquid crystal film structure than a central area. In some embodiments, applying pressure as in Step 307 may be conducted in an environment or chamber where the flexible liquid crystal film structure, the adhesive and the carrier are all under reduced pressure, i.e., pressure lower than atmospheric pressure. For example, applying pressure may be conducted in an environment having a gas pressure of less than 100, 50, 10, 5, or 1 Torr. The gas can be nitrogen, argon, or a mixture such as air. Laminating under reduced pressure may reduce the occurrence of trapped air that may result in bubbles. In some embodiments, post processing through an autoclave may also reduce or eliminate trapped air. In some embodiments, lamination may be performed using a vacuum bag process.

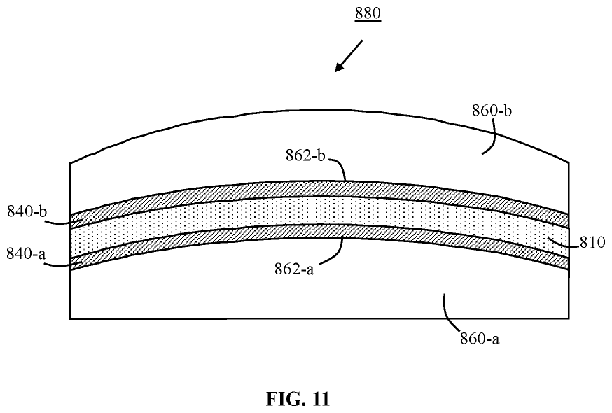

In some embodiments, an optical device may include two carriers. FIG. 11 is a cross-sectional view of an optical device according to some embodiments. Optical device 880 includes a first carrier 860-a having a multicurved surface 862-a. Optical device 880 further includes a flexible liquid crystal film structure 810 conformally provided over the multicurved surface 862-a of the first carrier 860-a. An interposed first adhesive 840-a adheres the flexible liquid crystal film structure 810 to the multicurved surface 862-a. A second carrier 860-b having a multicurved surface 862-b may be provided over the flexible liquid crystal film structure 810. An interposed second adhesive 840-b adheres the multicurved surface 862-b to the flexible liquid crystal film structure 810. Flexible liquid crystal film structure 810 may be as described above including first and second substrates, EOM, spacers, alignment layers, conductive layers, and other features, but these are omitted for clarity. Similarly, the first and second adhesives, first and second carriers, and certain lamination methods may include any as described above.

In some embodiments, a two-step lamination process may be used to make an optical device 880. For example, as a first step, the flexible liquid crystal structure 810 may be lamination—formed to the first carrier's multicurved surface 862-a. As a second step, the second carrier may be laminated or otherwise bonded to the upper surface of the lamination-formed liquid crystal structure. In some cases, the second step does not involve lamination forming since the flexible liquid crystal structure may already have its desired shape. Alternatively, as a first step, the flexible liquid crystal structure 810 may be lamination-formed to the second carrier's multicurved surface 862-b, and in a second step the first carrier may be laminated or otherwise bonded to the lower surface of the lamination-formed liquid crystal structure.

In some embodiments, an optical device may have only a single carrier and one or more lamination-formed liquid crystal film structures. Such structures may in some cases be simpler to manufacture. For example, an augmented reality headset as the carrier may include one or more lamination-formed liquid crystal film structures, but not an overlaying second carrier such as a glass plate or the like.

In the preceding figures and description, the flexible liquid crystal film structure has generally been described as flat prior to lamination forming. However, in some embodiments, the flexible liquid crystal film structure may have some partial curvature prior to lamination forming. That is, the flexible liquid crystal film structure to undergo lamination forming may be non-flat but not yet have the full curvature of the multicurved surface of the carrier.

In some embodiments, the flexible liquid crystal film structure includes the EOM at the time of lamination, i.e., applying pressure. Having the gap filled with EOM may help distribute pressure between the two substrates of the flexible liquid crystal film structure. However, in some embodiments, the EOM may be added after applying pressure using filling methods discussed above (e.g., vacuum filling). In some cases, the EOM may be sensitive to pressure or optional heating or additional curing steps that may be used during bonding with the PAA, and so adding it later may be preferred. Alternatively, the gap may be temporarily filled with a material to aid in distributing pressure between substrates, e.g., with a harmless low vapor pressure solvent while applying pressure, then removed after the applying pressure step and refilled with the desired EOM. A non-limiting example of such low vapor pressure solvents may include certain hydrofluoroethers.

Methods and materials of the present disclosure enable the manufacture of optical devices that do not have the drawbacks associated with thermoformed LC devices mentioned previously. Such optical devices can be made in high yield, and surprisingly without defects such as wrinkling of the flexible liquid crystal film structure, which might be expected when laminated over a multicurved surface without thermoforming. Optical devices of the present disclosure may have high optical clarity/low haze and low driving voltages.

Additional layers or materials may optionally be applied to protect the optical device surface or edges against damage from scratches, UV radiation, moisture or the like. Such additional layers or materials may also or instead enhance some performance feature such as antireflection, polarization, tints or the like.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the invention has been presented for the purposes of illustration and description. It is not intended to be exhaustive or to limit the invention to the precise form described, and many modifications and variations are possible in light of the teaching above.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Additionally, details of any specific embodiment may not always be present in variations of that embodiment or may be added to other embodiments.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a method” includes a plurality of such methods and reference to “the layer” includes reference to one or more layers and equivalents thereof known to those skilled in the art, and so forth. The invention has now been described in detail for the purposes of clarity and understanding. However, it will be appreciated that certain changes and modifications may be practiced within the scope of the appended claims.

All publications, patents, and patent applications cited herein are hereby incorporated by reference in their entirety for all purposes.

1. An optical device comprising:
a low-flexibility carrier having a multicurved surface;
a flexible liquid crystal film structure conformally provided over the multicurved surface; and
an adhesive interposed between the multicurved surface and the liquid crystal film structure, wherein the flexible liquid crystal film structure is lamination-formed to the shape of the multicurved surface, wherein the adhesive comprises a pressure-activated adhesive.

2-3. (canceled)

4. The optical device of claim 1, wherein the liquid crystal film structure comprises a first flexible substrate in contact with the adhesive, a second flexible substrate spaced apart from the first flexible substrate to form a gap, and an electro-optic material provided in the gap and enclosed by a border seal.

5. The optical device of claim 4, wherein the electro-optic material comprises a guest-host dichroic dye-liquid crystal mixture.

6. The optical device of claim 4, wherein the electro-optic material contains less than 10% by weight of polymeric material.

7-8. (canceled)

9. The optical device of claim 4, wherein over at least 95% of the liquid crystal film structure area, the gap is maintained within 20% of an average gap measured over the entire liquid crystal film structure area.

10. The optical device of claim 9, wherein the average gap is in a range of 5 μm to 10 μm.

11. The optical device of claim 4, wherein the first substrate, the second substrate, or both, comprise a flexible polymeric material.

12-15. (canceled)

16. The optical device of claim 1, wherein the adhesive comprises a viscoelastic polymer and a tackifier.

17. The optical device of claim 1, wherein the adhesive has an average thickness in a range of 25 μm to 250 μm.

18. (canceled)

19. The optical device of claim 1, wherein the multicurved surface is characterized by:
i) a first curvature having a first height H1 and a first length L1 measured along a first direction, wherein a first curvature ratio C1=H1/L1; and
ii) a second curvature having a second height H2 and second length L2 measured along a second direction orthogonal to the first direction, wherein a second curvature ratio C2=H2/L2,
wherein both C1 and C2 are greater than zero, and at least one of C1 and C2 is less than 0.5.

20. The optical device of claim 1, wherein multicurved surface is characterized by:
i) a first curvature curved to a first value of greater than 0 diopter; and
ii) a second curvature orthogonal to the first curvature and curved to a second value of greater than 0 diopter,
wherein at least one of the first value and second value is less than 8 diopter.

21. (canceled)

22. The optical device of claim 1, wherein the area of the multicurved surface is between 2.0 and 15% greater than a virtual area defined by projection of the multicurved surface onto a flat surface.

23-24. (canceled)

25. The optical device of claim 1, wherein the carrier comprises a window, a windshield, a cockpit, a display, a heads-up display, a sunroof, a mirror, a headset for augmented reality or virtual reality, goggles, a visor, a lens, glasses, or sunglasses.

26-27. (canceled)

28. A method of making an optical device, the method comprising:
providing a low-flexibility carrier having a multicurved surface;
providing a flexible liquid crystal film structure comprising:
a first flexible substrate; and
a second flexible substrate spaced apart from the first flexible substrate to form a gap designed to contain an electro-optic material,
wherein an outer surface of the first flexible substrate corresponds to a first surface of the flexible liquid crystal film structure and an outer surface of the second flexible substrate corresponds to a second surface of the flexible liquid crystal film structure;
applying an adhesive to i) the multicurved surface, ii) the first surface of the flexible liquid crystal film structure, or iii) both (i) and (ii);
aligning the carrier to the flexible liquid crystal film structure;
applying pressure between the multicurved surface and the first surface of the flexible liquid crystal film structure to shape the flexible liquid crystal film structure in accordance with the multicurved surface of the carrier; and
conformally adhering the shaped flexible liquid crystal film structure to the multicurved surface to create a lamination-formed liquid crystal film structure, wherein the adhesive comprises a pressure-activated adhesive and applying pressure causes the adhering.

29. (canceled)

30. The method of claim 28, wherein the adhesive comprises a curable adhesive and the adhering further comprises a curing step.

31. (canceled)

32. The method of claim 30, wherein the curable adhesive is in the form of a fluid or gel.

33. The method of claim 28, wherein the steps of applying pressure and conformally adhering are performed at a temperature of 60° C. or less.

34. The method of claim 33, wherein applying pressure comprises contacting the carrier, the second surface of the flexible liquid crystal film structure, or both, with one or more rollers.

35. The method of claim 34, wherein at least one roller is a deformable roller.

36. The method of claim 34 wherein at least one roller has a concave lateral shape that applies pressure to a convex portion of the multicurved surface, or wherein at least one roller has a convex lateral shape that applies pressure to a concave portion of the multicurved surface.

37. (canceled)

38. The method of claim 34, wherein at least one roller is heated to a temperature of least 30° C. and at least 10° C. lower than a Tg of either the first substrate or the second substrate.

39. (canceled)

40. The method of claim 28, wherein applying pressure comprises contacting the second surface of the flexible liquid crystal film structure with a mold having a mold face, the mold face having a shape corresponding to the shape of the multicurved surface.

41. (canceled)

42. The method of claim 40 wherein the mold is heated to a temperature of least 30° C. and at least 10° C. lower than a Tg of either the first substrate or the second substrate.

43. (canceled)

44. The method of claim 28, wherein the electro-optic material is provided into the gap and enclosed by a border seal prior to applying pressure between the multicurved surface and the first surface of the flexible liquid crystal film structure.

45. The method of claim 28, wherein the electro-optic material is provided into the gap and enclosed by a border seal after applying pressure between the multicurved surface and the first surface of the flexible liquid crystal film structure.

46. The method of claim 28, wherein applying pressure between the multicurved surface and the first surface of the flexible liquid crystal film structure is conducted in an environment having a gas pressure of less than 100 Torr.

47. The method of claim 28, wherein aligning the carrier to the flexible liquid crystal film structure further comprises contacting the adhesive, the multicurved surface and the first surface of the flexible liquid crystal film structure at one end of the carrier.

48. The method of claim 28, wherein aligning the carrier to the flexible liquid crystal film structure further comprises contacting the adhesive, the multicurved surface and the first surface of the flexible liquid crystal film structure at a central region of the carrier.

49. (canceled)
